(19) United States
(12) Patent Application Publication
(10) Pub. No.: US 2007/0081367 A1
(43) Pub. Date: Apr. 12, 2007

(54) Diode power array

(75) Inventor: Bruce Hammond, Castro Valley, CA (US)

Correspondence Address: Hani Z. Sayed, Esq.;c/o Rutan & Tucker, LLP, 611 ANTON BLVD, SUITE 1400, COSTA MESA, CA, 92626, US

(73) Assignee: MVM Technologies, Inc.

(21) Appl. No.: 11/246,728

(22) Filed: Oct. 6, 2005

(51) Int. Cl. H02M 7/04

(52) U.S. Cl. 363/89

(57) ABSTRACT

A circuit for parasitically powering a device comprises diodes, a capacitor, and an inductor all disposed across a signal line, the inductor disposed in series between the diodes and the capacitor. The first diode is preferably a rectification diode, the second diode is preferably a flyback diode, and a DC/DC power supply circuit is preferably disposed across the capacitor. Multiple signal lines are contemplated. The parasitic voltage circuit can include a resistor and a MOSFET in series with the first diode and the inductor, more preferably an impedance control circuit that generates a pulse width modulated signal to actuate the MOSFET, and still more preferably, the impedance control circuit can turn the MOSFET on and off at a rate and duty cycle commensurate with maintaining a relatively constant current from the signal line through rectification diode Ds.

### FIELD OF THE INVENTION

The field of the invention is power supplies, and more particularly to devices and methods for parasitically powering electronic circuits.

### BACKGROUND

Parasitically powered electronic devices derive their power from the power transmitted over an attached signal line, usually a serial data interconnection, that will typically alternate between a high and a low voltage state during data transmissions and then remain in a high or low voltage state when the data transmission is complete. The signal line is usually driven low with a MOSFET Qd and pulled high by a resistor Rp tied to a power supply as shown in FIG. 1.

When the signal line is at the high voltage state, an onboard power storage capacitor Ca on the electronic device will be charged to the signal line's potential minus the voltage drop across an in-line diode Ds at a charge rate determined by the signal line's pull-up resistor and the value of the storage capacitor. The pull-up resistor Rp on the signal line will determine the maximum power available from the signal line.

When the signal line goes to the low voltage state, the device can no longer derive its power from the signal line's potential, and will then be powered by the onboard power storage capacitor Ca. At this time, the on-board power storage capacitor Ca will discharge until the signal line returns to the high voltage state or the device circuitry can no longer operate properly. The maximum time the electronic circuit can function properly while the signal line is in the low voltage state is determined by the charge on the storage capacitor and the electrical load of the electronic circuit. The optimum value of the storage capacitor Ca will be determined by the timing characteristics of the data transmitted on the signal line, the electrical load of the electronic circuit and the value of the pull-up resistor Rp used to bring the signal line to the high voltage state. As a result, parasitically powered electronic devices must be designed to minimize power consumption while the signal line is at a low potential to reduce the possibility of the device circuitry resetting unexpectedly.

Current parasitically powered electronic devices are also limited to a maximum voltage determined by the signal line's high voltage state. In circumstances where a higher voltage is required, batteries coupled with a DC/DC boost power supply are typically the solution of choice rather than using the power available on the signal line since the transient current requirements of a DC/DC boost power supply are normally more than can be supported by the intrinsic impedance of the data line and can cause unwanted transmission of radio frequency interference (RFI) to other electronic circuits.

Thus, there is still a need for devices and methods for obtaining power from a signal line, preferably without degrading the performance of the signal line, while boosting the voltage obtained from the signal line to a higher voltage suitable for providing one or more regulated voltages to an electronic device, and/or limiting the transient current requirements of the DC/DC boost power supply to match the intrinsic impedance of the data line thereby minimizing RFI.

### SUMMARY OF THE INVENTION

The present invention provides systems and methods in which a circuit for parasitically powering a device comprises first and second diodes, a capacitor, and a first inductor all disposed across the signal line, the inductor disposed in series between the diodes and the capacitor. In preferred embodiments, the first diode is a rectification diode, and the second diode is a flyback diode, and a DC/DC power supply circuit is disposed across the capacitor.

The inventive concepts can be utilized with two, three, or more signal lines. For example, a second rectification diode can be disposed across a second signal line, and using a common signal return with the first signal line. In such instances it is contemplated that additional inductors can be utilized, such that, for example, a second signal line contributes current to the capacitor through a second inductor.

In yet another inventive aspect, the parasitic voltage circuit can include a resistor and a MOSFET in series with the first diode and the inductor. More preferably, the parasitic voltage circuit can include an impedance control circuit that generates a pulse width modulated signal to turn the MOSFET on and off. Still more preferably, the impedance control circuit can turn the MOSFET on and off at a rate and duty cycle commensurate with maintaining a relatively constant current from the signal line through rectification diode as determined by comparing the voltage across the resistor integrated over time against two reference voltages.

Advantages of these improvements to the field should be readily apparent. For example, devices and methods of the present invention provides a means for powering an add-on electronic device when it is impractical for it to be directly powered by the electronic device to which it will be attached, from an external AC/DC power supply or from batteries. Aspects of the present invention also provides power from one or more signal lines, and provides regulation of the power thus obtained at one or more voltage levels, as needed to power an electronic device intended as an add-on to an existing electronic system. The advantages are especially desirable in the absence of easily accessible dedicated power supply connections included with the connections for the signal lines.

### BRIEF DESCRIPTION OF THE DRAWING

FIG. 1 is schematic of a prior art parasitic power supply.

FIG. 2 is a schematic of a diode array power supply having an inductor La in series between the rectification diode Ds and the storage capacitor Ca.

FIG. 3 is a schematic of a diode array power supply having accommodate multiple signal lines by adding rectification diodes Ds1 through Dsn, with one diode for each signal line.

FIG. 4 is a schematic of a diode array power supply that further accommodates multiple signal lines with lower impedance and higher current capability by adding rectification diodes Ds1 through Dsn, flyback diodes Df1 through Dfn and inductors La1 through Lan, with one pair of diodes and an inductor for each signal line.

FIG. 5 is a schematic of a diode array power supply that accommodate signal lines that require a minimum load impedance by adding resistor Rs in series with the rectification diode Ds and inductor La.

FIG. 6 is a schematic of a diode array power supply that accommodates signal lines that require a more constant load impedance by adding resistor Rc and MOSFET Qr in series with the rectification diode Ds and inductor La.

FIG. 7 is a schematic of a diode array power supply impedance control circuit that generates a pulse width modulated signal to turn MOSFET Qr on and off at a rate and duty cycle commensurate with maintaining a relatively constant current from the signal line through rectification diode Ds.

### DETAILED DESCRIPTION

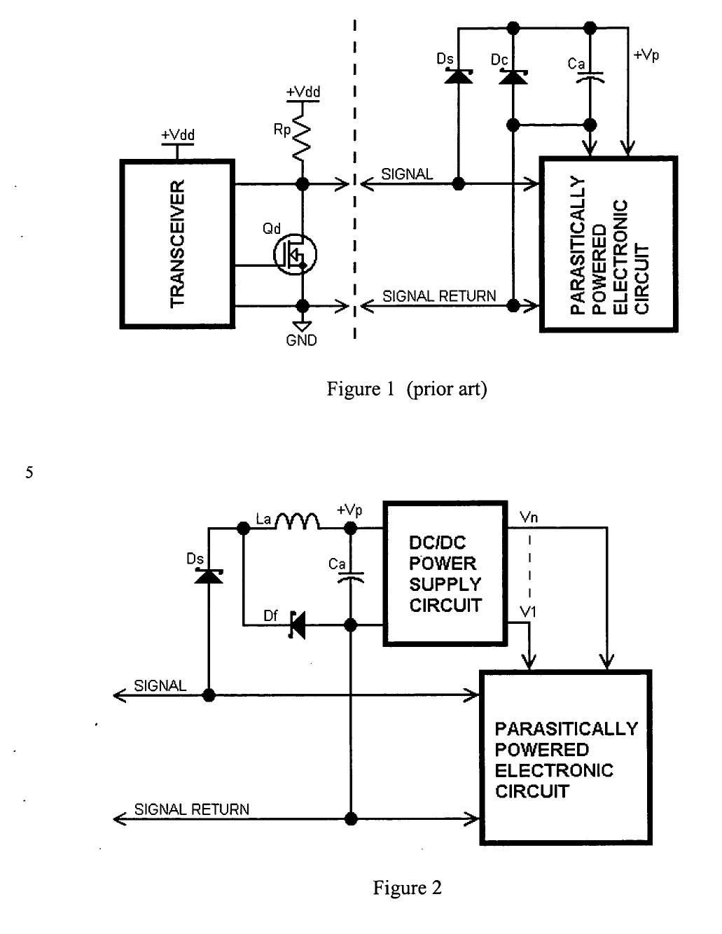

Referring to FIG. 2, the present invention improves on the prior technology by adding an inductor La in series between the rectification diode Ds and the storage capacitor Ca. The clamp diode Dc in FIG. 1 is replaced by flyback diode Df.

When the signal line goes to the high voltage state, current begins to flow through rectification diode Ds and through inductor La to the storage capacitor Ca. This current will increase over time according to the time constant determined by the values of inductor La and storage capacitor Ca and will be limited to a maximum current as determined by the source impedance of the signal line.

When the signal line returns to the low voltage state, rectification diode Ds will turn off and flyback diode Df will turn on, allowing current to continue flowing through inductor La. This current will decrease over time according to the energy stored in inductor La and the time constant determined by the values of inductor La and storage capacitor Ca.

The DC/DC power supply circuit will provide one or more regulated voltage output to the electronic circuit (as needed) so that the electronic circuit will be somewhat isolated from the variability of the voltage on storage capacitor Ca. This DC/DC power supply circuit can be any topology, although it does need to be as efficient as possible to avoid wasting the limited power available from the signal line.

Inductor La and storage capacitor Ca act as an input filter to the DC/DC power supply circuit to prevent the switching noise from getting onto the signal line.

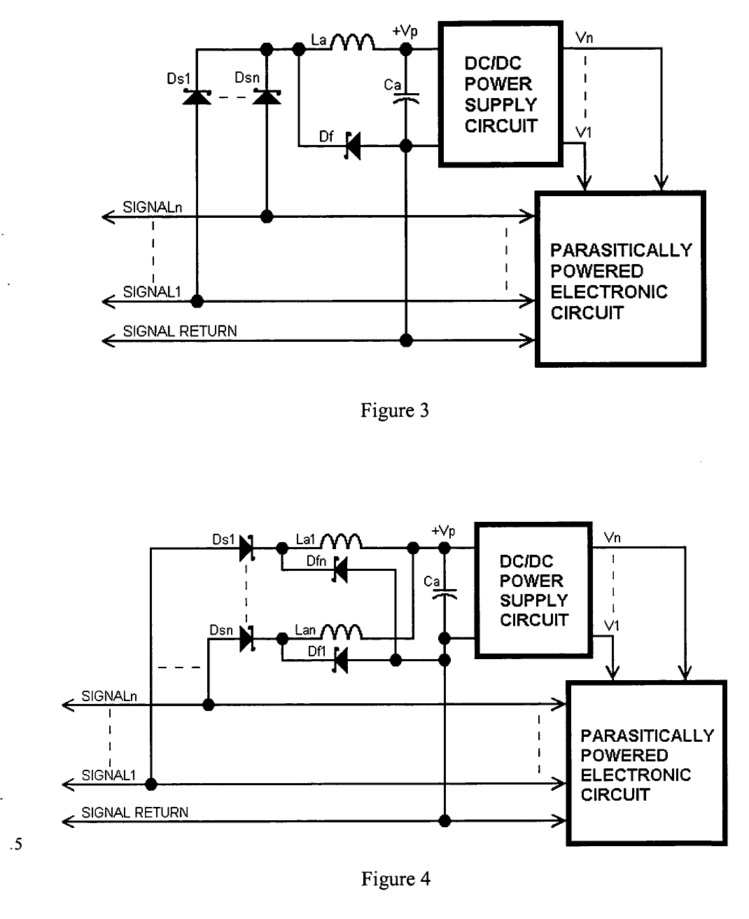

Referring to FIG. 3, the present invention can also accommodate multiple signal lines by adding rectification diodes Ds 1 through Dsn, with one diode for each signal line.

When one or more signal lines goes to the high voltage state, current will begin to flow through the corresponding rectification diode Dsx (Ds1 through Dsn) and through inductor La to the storage capacitor Ca. The current from each signal line will increase over time according to the time constant determined by the values of inductor La and storage capacitor Ca and will be limited to a maximum current as determined by the source impedance of the signal line.

When one of the signal lines returns to the low voltage state with one or more of the other signal lines still at the high voltage state, the corresponding rectification diode Dsx will turn off and the rectification diodes corresponding to the signal lines that are still high will continue allowing current to continue flowing through inductor La. This current will decrease over time to a level commensurate with the signal lines that are still in the high voltage state, and will decrease at a rate determined by the energy stored in inductor La and the time constant determined by the values of inductor La and storage capacitor Ca.

When all of the signal lines return to the low voltage state, the corresponding rectification diodes Ds1 through Dsn will turn off and flyback diode Df will turn on, allowing current to continue flowing through inductor La. This current will decrease over time according to the energy stored in inductor La and the time constant determined by the values of inductor La and storage capacitor Ca.

As in the previous implementation using a single signal line, the DC/DC power supply circuit will provide one or more regulated voltage to the electronic circuit (as required) so that the electronic circuit will be somewhat isolated from the variability of the voltage on storage capacitor Ca. This DC/DC power supply circuit can be any topology, although it does need to be as efficient as possible to avoid wasting the limited power available from the signal line.

And as in the previous implementation using a single signal line, inductor La and storage capacitor Ca act as an input filter to the DC/DC power supply circuit to prevent the switching noise from getting onto the signal lines.

Referring to FIG. 4, the present invention can also accommodate multiple signal lines with lower impedance and higher current capability by adding rectification diodes Ds1 through Dsn, flyback diodes Df1 through Dfn and inductors La1 through Lan, with one pair of diodes and an inductor for each signal line.

For this implementation, each signal line will be contributing current to the storage capacitor Ca through the associated inductor rather than through a common inductor as in FIG. 3.

When each signal line goes to the high voltage state, current will begin to flow through the associated rectification diode Dsx and through the associated inductor Lax to the storage capacitor Ca. This current will increase over time according to the time constant determined by the values of inductor Lax and storage capacitor Ca and will be limited to a maximum current as determined by the source impedance of the signal line.

When each signal line returns to the low voltage state, the associated rectification diode Dsx will turn off and the associated flyback diode Dfx will turn on, allowing current to continue flowing through the associated inductor Lax. This current will decrease over time according to the energy stored in inductor Lax and the time constant determined by the values of inductor Lax and storage capacitor Ca.

As in the previous implementation using a single signal line, the DC/DC power supply circuit will provide one or more regulated voltage to the electronic circuit (as required) so that the electronic circuit will be somewhat isolated from the variability of the voltage on storage capacitor Ca. This DC/DC power supply circuit can be any topology, although it does need to be as efficient as possible to avoid wasting the limited power available from the signal line.

And as in the previous implementation using a single signal line, inductors Lax and storage capacitor Ca act as input filters to the DC/DC power supply circuit to prevent the switching noise from getting onto the signal lines.

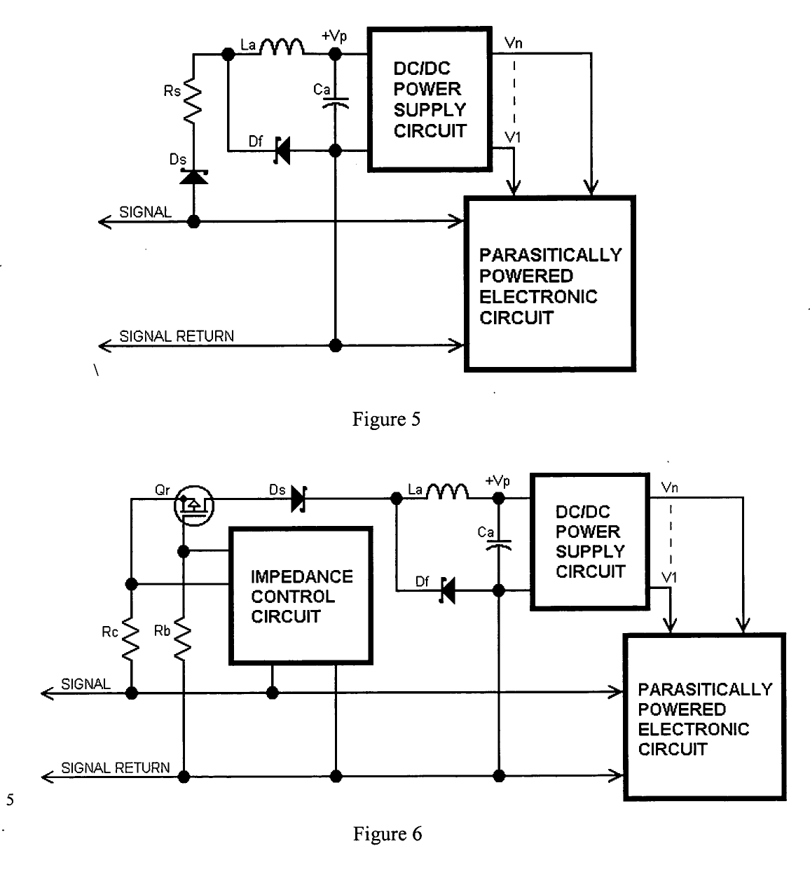

Referring to FIG. 5, the present invention can also accommodate signal lines that require a minimum load impedance by adding resistor Rs in series with the rectification diode Ds and inductor La. It is understood that this resistor can be added in series to the rectification diodes for each signal line used.

Operation will be the same as detailed above except that the maximum current flow from a signal line will now be limited by resistor Rs as well as the signal line source impedance.

As in the previous implementation using a single signal line, the DC/DC power supply circuit will provide one or more regulated voltage to the electronic circuit (as required) so that the electronic circuit will be somewhat isolated from the variability of the voltage on storage capacitor Ca. This DC/DC power supply circuit can be any topology, although it does need to be as efficient as possible to avoid wasting the limited power available from the signal line.

And as in the previous implementation using a single signal line, inductors Lax and storage capacitor Ca act as input filters to the DC/DC power supply circuit to prevent the switching noise from getting onto the signal lines.

Referring to FIG. 6, the present invention can also accommodate signal lines that require a more constant load impedance by adding resistor Rc and MOSFET Qr in series with the rectification diode Ds and inductor La. It is understood that impedance control circuits can be added for each signal line in use.

On initial power-up, bias resistor Rb will allow the MOSFET Qr to conduct current when the signal line goes to the high state, similar to the operation as detailed in previous sections. Once the storage capacitor has sufficient voltage to enable the DC/DC power supply and the electronic circuits, the impedance control circuit will begin to operate.

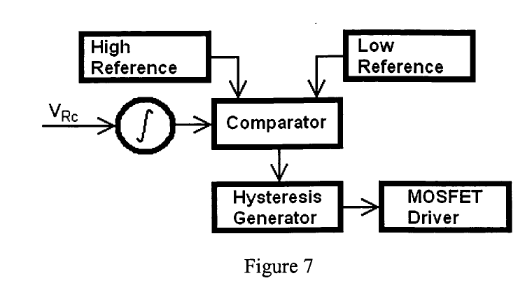

Referring to FIG. 7, the impedance control circuit will generate a pulse width modulated signal to turn MOSFET Qr on and off at a rate and duty cycle commensurate with maintaining a relatively constant current from the signal line through rectification diode Ds as determined by comparing the voltage across resistor Rc integrated over time against two reference voltages.

Whenever the voltage across Rc integrated over time is greater than the higher reference voltage, MOSFET Qr will be turned off to stop current flow through the rectification diode Ds.

Whenever the voltage across Rc integrated over time is less than the lower reference voltage, MOSFET Qr will be turned on to allow current to flow through the rectification diode Ds.

Thus, specific embodiments and applications of diode array power supplies have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A circuit for parasitically powering a device from a first signal line, comprising first and second diodes, a capacitor, and a first inductor all disposed across the signal line, the inductor disposed in series between the diodes and the capacitor.

2. The circuit of claim 1, where in the first diode is a rectification diode, and the second diode is a flyback diode.

3. The circuit of claim 2, further comprising a DC/DC power supply circuit disposed across the capacitor.

4. The circuit of claim 2, further comprising a second rectification diode disposed across a second signal line, and using a common signal return with the first signal line.

5. The circuit of claim 4, further comprising a second inductor, disposed such that the first signal line contributes current to the capacitor through the first inductor, and the second signal line contributes current to the capacitor through the second inductor.

6. The circuit of claim 2, further comprising a resistor and a MOSFET in series with the first diode and the inductor.

7. The circuit of claim 6, further including an impedance control circuit that generates a pulse width modulated signal to turn the MOSFET on and off.

8. The circuit of claim 7, wherein the impedance control circuit turns the MOSFET on and off at a rate and duty cycle commensurate with maintaining a relatively constant current from the signal line through rectification diode as determined by comparing the voltage across the resistor integrated over time against two reference voltages.
